(19) United States
(12) Patent Application Publication
(10) Pub. No.: US 2012/0070257 A1
(43) Pub. Date: Mar. 22, 2012

(54) CONTAINER LOADING METHOD AND APPARATUS

(75) Inventor: David Richard Dunn, Dudley (GB)

(73) Assignee: DUNN BROTHERS MACHINERY LIMITED, Dudley (GB)

(21) Appl. No.: 13/322,295

(22) PCT Filed: Dec. 24, 2009
(86) PCT No.: PCT/GB09/02967

§ 371 Date: Nov. 23, 2011

(30) Foreign Application Priority Data
May 28, 2009 (GB) 0909120.8

(51) Int. Cl. B65G 65/32

(52) U.S. Cl. 414/293

(57) ABSTRACT

A method of loading a shipping container (26) is described comprising moving the container from a horizontal transport condition to a vertical loading condition, and loading the container in the loading condition. Apparatus (10) for carrying out the method are also described. The apparatus includes a base frame (12), a support frame (14) and an actuator (18b).

The present invention relates to apparatus and methods for container loading, and particularly but not exclusively to container loading apparatus for loading shipping containers.

It is known to provide shipping containers of standardised size, typically 20 ft or 40 ft in length, and which will typically have a load capacity of around 25 tonnes of material. A variety of methods are known for loading such containers, one such method being the “loose fill” method, in which material such as shredded scrap metal waste is loaded into a container with an excavator or grab. Such methods are relatively time consuming and inefficient.

According to a first aspect of the present invention, there is provided container loading apparatus for loading a shipping container, the apparatus including a base frame, a support frame for supporting a container, a mounting for mounting the support frame to the base frame, one or more securing devices for securing the container to the support frame, and an actuator which is operable to move the support frame between a first condition and a second condition.

Thus in use, a container secured to the support frame is movable between a transport condition corresponding to the first condition and a loading condition corresponding to the second condition.

Possibly, in the second condition, the support frame is angled relative to its position in the first condition, and may be rotated through approximately 90° relative to its position in the first condition.

Possibly, the container is elongate. Possibly, in the transport condition, the length of the container extends substantially horizontally.

Possibly the container defines an opening at one end, and may includes doors, which may be moveable to close the opening.

Possibly in the loading condition, the length of the container is angled relative to the horizontal, and may be substantially vertical. Possibly in the loading condition, the opening faces substantially upwards.

Possibly the container may be carried by a vehicle in the transport condition.

Possibly, the apparatus defines a loading space, which may be open at each end, so that in use, a vehicle carrying to container can drive therethrough.

The apparatus may include one or more guides to guide a vehicle as it drives into the loading space.

Possibly, the apparatus is arranged so that as a container is moved between the transport and the loading conditions, the centre of the gravity of the container remains above the loading space.

Possibly, the support frame includes an end wall support, which, in the loading condition, may support an end wall of the container. Possibly the supported end wall is the wall opposite to the one end defining the opening. The end wall support may be arranged to bear substantially the entire weight of a container (and possibly its load) when the support frame is in the second position.

The securing devices may each comprise a respective engaging part, which is operable in use to engage with respective engaging formations provided on the container, so as to connect the securing device to the container.

The securing devices may comprise a plurality of flexible securing members. The flexible securing members may be connected, in use, at a first end to the support frame and at a second end to the container. The flexible securing members may comprise wire rope, and may comprise chains or cables, for example.

Possibly, the actuator, or one or more additional actuators, may be arranged to move, in use, the container between the transport condition and an intermediate condition in which the container is supported by the support frame, and between the intermediate condition and the loading condition. For example, the actuators may move the support frame from the first condition to an intermediate condition, before the support frame is moved to the second condition.

The apparatus may be arranged so that in the first condition and/or the intermediate condition the weight of a container is substantially borne by the support devices. The apparatus may be arranged so that in the second condition the weight of a container is substantially borne by the end wall support. Alternatively, the apparatus may be arranged so that the weight of a container substantially always borne by the support devices.

Possibly, the apparatus includes a ladder arrangement, which may be mounted to the support frame. Possibly, the apparatus includes a walkway, which may be pivotally mounted to the support frame, and may be movable between a storage condition and a use condition. Possibly, in use, with the container secured to the support frame in the loading condition, and the walkway in the use condition, the ladder arrangement and the walkway together form an access path between the ground and the opening of the container.

The apparatus may comprise location members which in use maintain a container in a substantially constant orientation with respect to the support frame. The location members may comprise one or more location pins provided on the walkway. Alternatively or additionally the location members may comprise one or more suitably shaped recesses provided in the end wall support within which, in use, an end of a container may be received. The end wall support may alternatively or additionally comprise securing devices, for example clamps, which are operable to secure the end wall support in use to the container.

According to a second aspect of the present invention, there is provided a method of loading a shipping container, the method including the steps of moving the container from a transport condition to a loading condition, and loading the container in the loading condition.

Possibly, the method includes moving the container using a container loading apparatus as described in any of the preceding statements.

Possibly, the container includes one or more doors, and the method includes the step of opening the or each container door in the transport condition. Possibly, the method includes the step of closing the or each door in the loading condition.

Possibly, the container loading apparatus defines a loading space, and the method includes the step of a vehicle entering the loading space at one end carrying the container. Possibly the method includes the step of the container being lifted from the vehicle. Possibly, the method includes the step of the vehicle leaving the loading space at another end. Possibly, the method includes a subsequent step of the vehicle re-entering the loading space at the other end, and the loaded container being repositioned onto the vehicle. Possibly, the vehicle then leaves the loading space at either the one end or the other end.

Embodiments of the present invention will now be described by way of example only and with reference to the accompanying drawings, in which:—

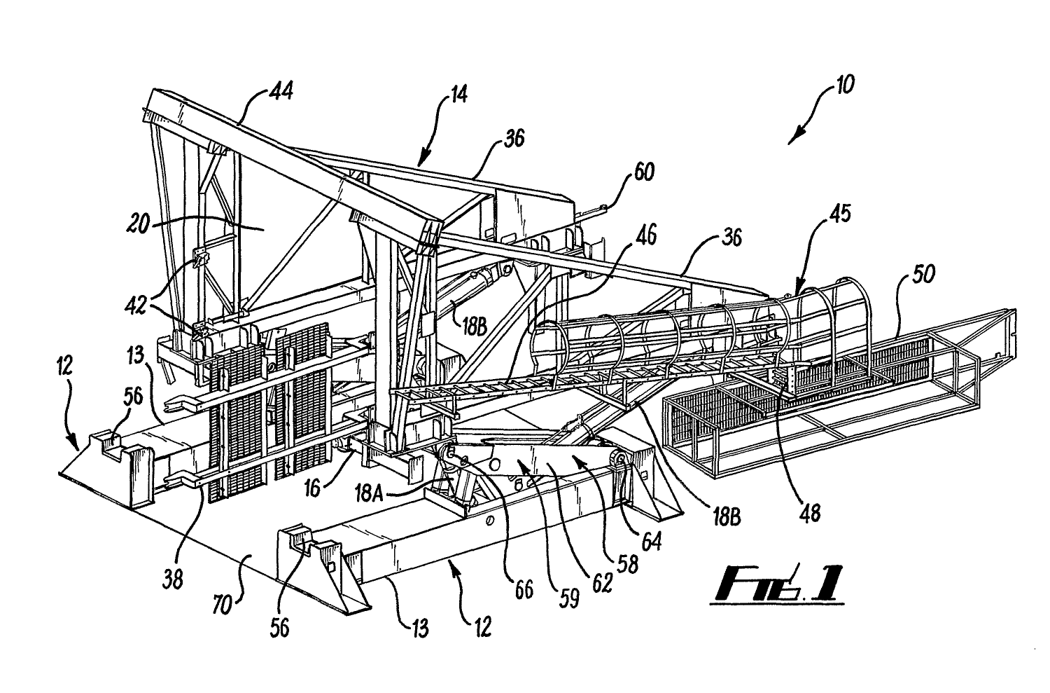

FIG. 1 is a perspective view of a container loading apparatus in a first condition;

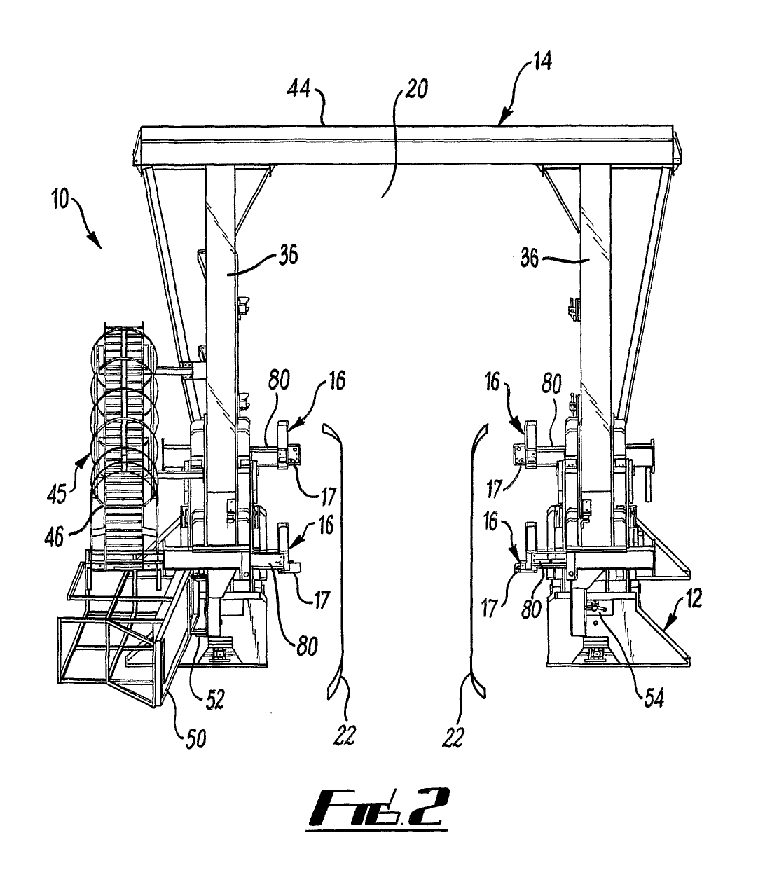

FIG. 2 is an end view of the container loading apparatus of FIG. 1;

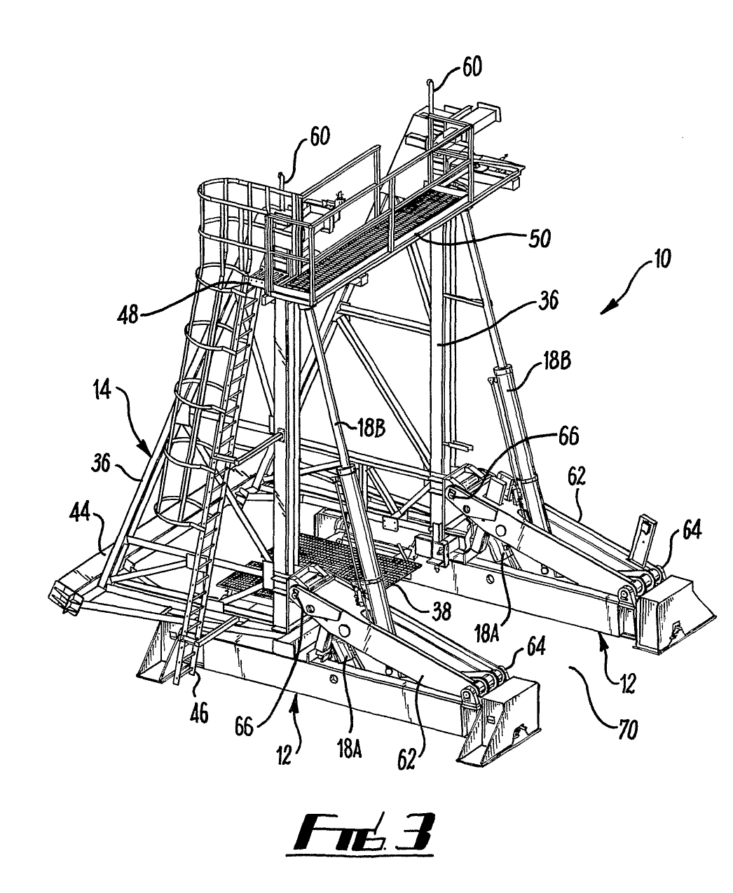

FIG. 3 is a perspective view of the loading apparatus in a second condition;

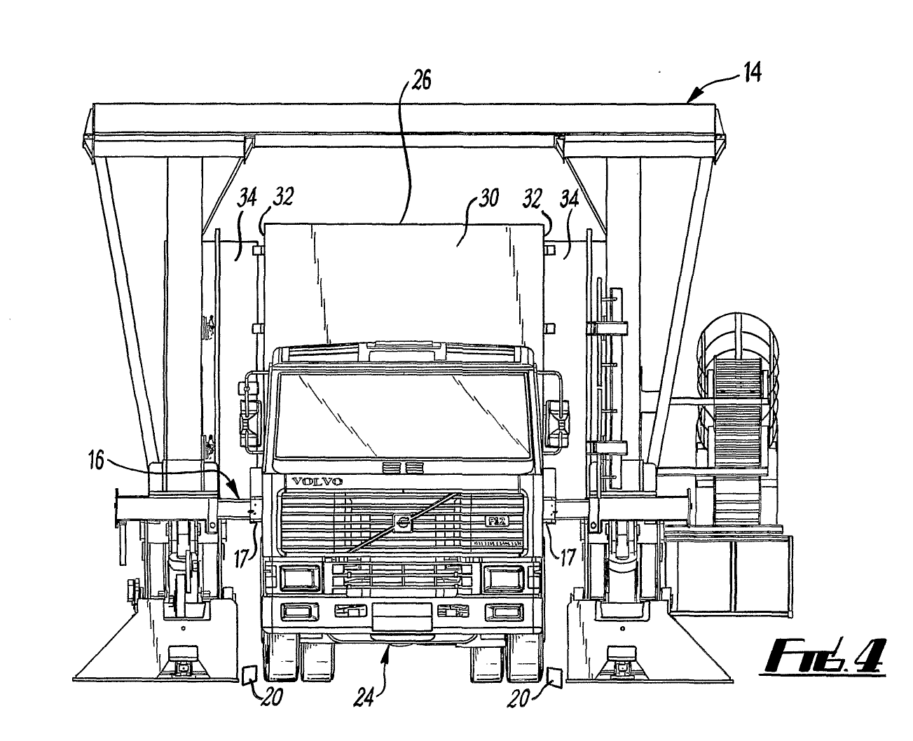

FIGS. 4 to 12 are views of successive steps in a method of loading a container, as follows:

FIG. 4 is an end view in the first condition;

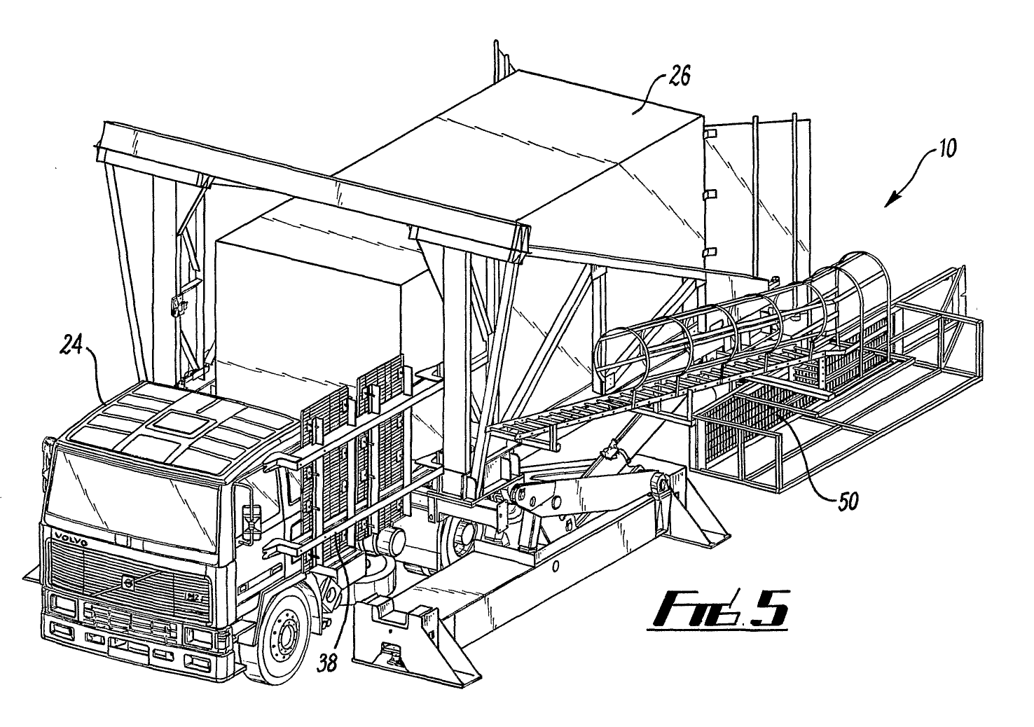

FIG. 5 is a perspective view in the first condition;

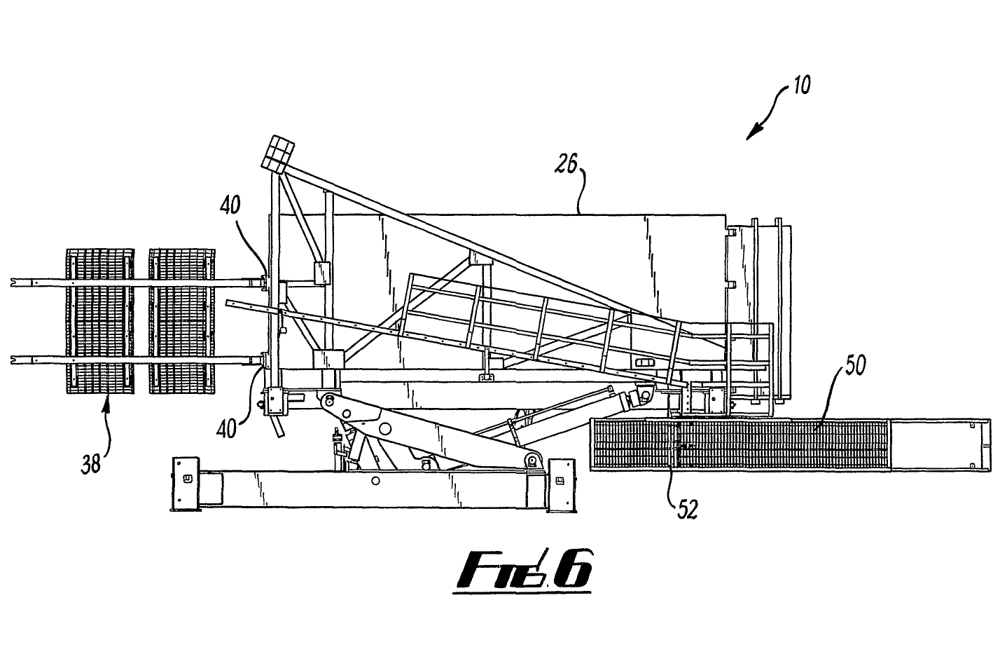

FIG. 6 is a side view in an intermediate condition;

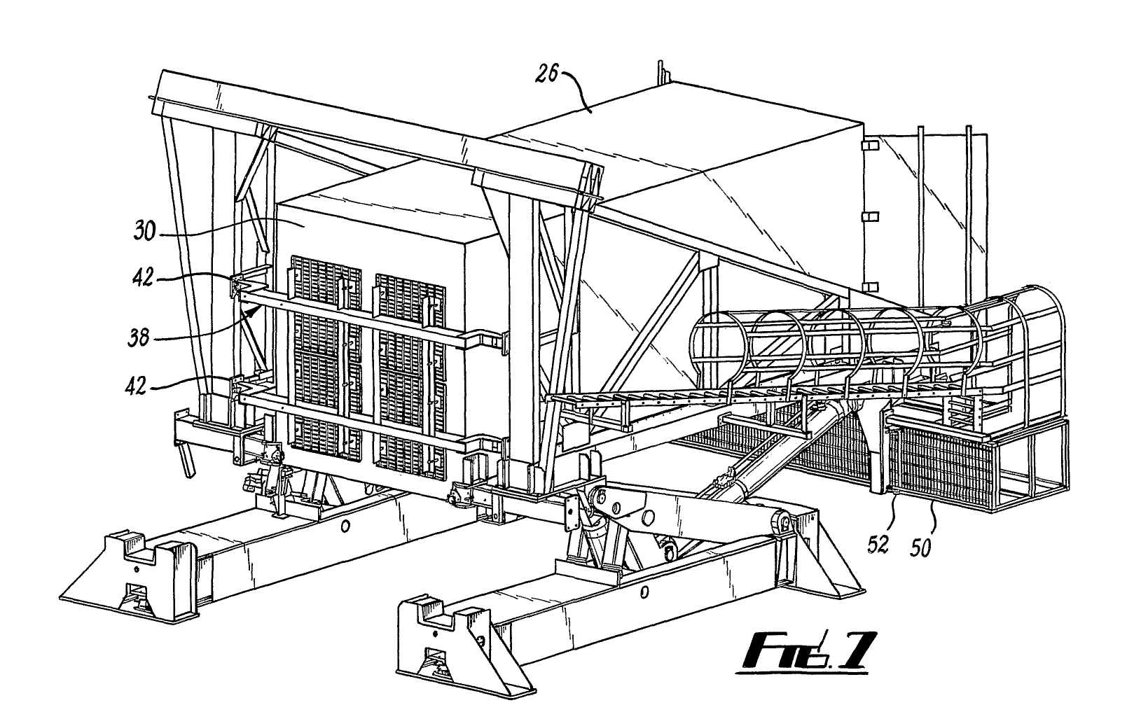

FIG. 7 is a perspective view in the intermediate condition;

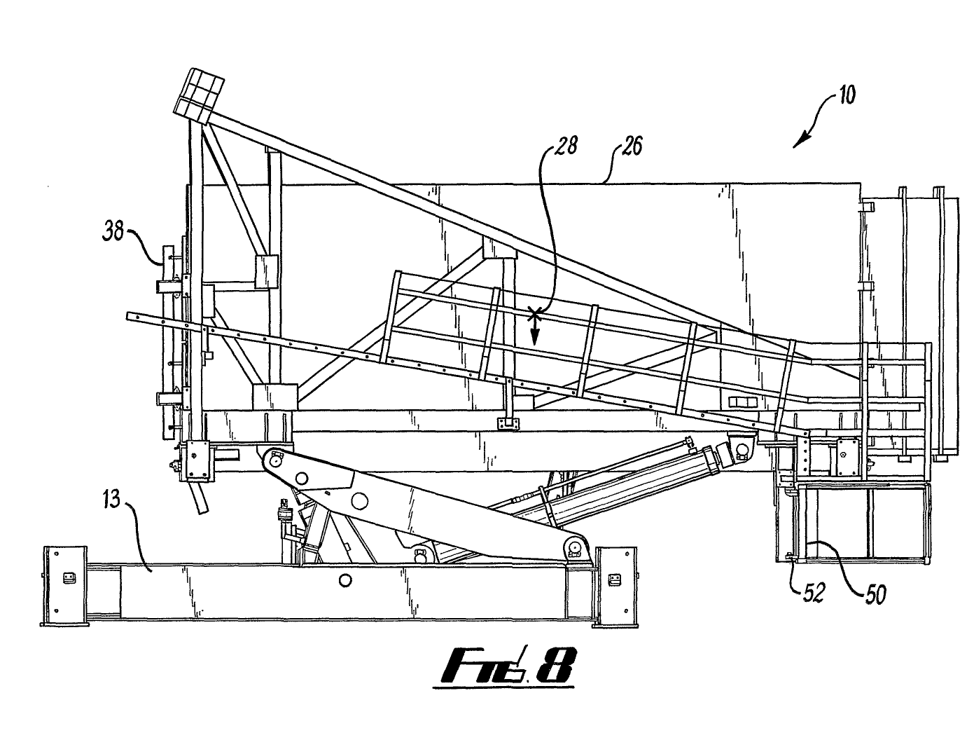

FIG. 8 is a side view in the intermediate condition;

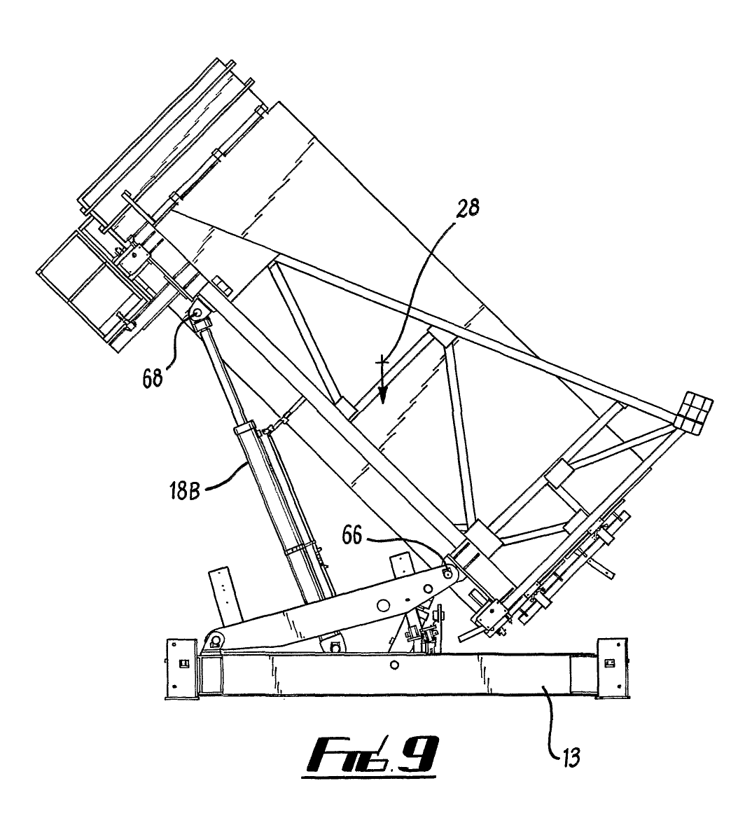

FIG. 9 is a side view of the apparatus being moved from the intermediate condition to the second condition;

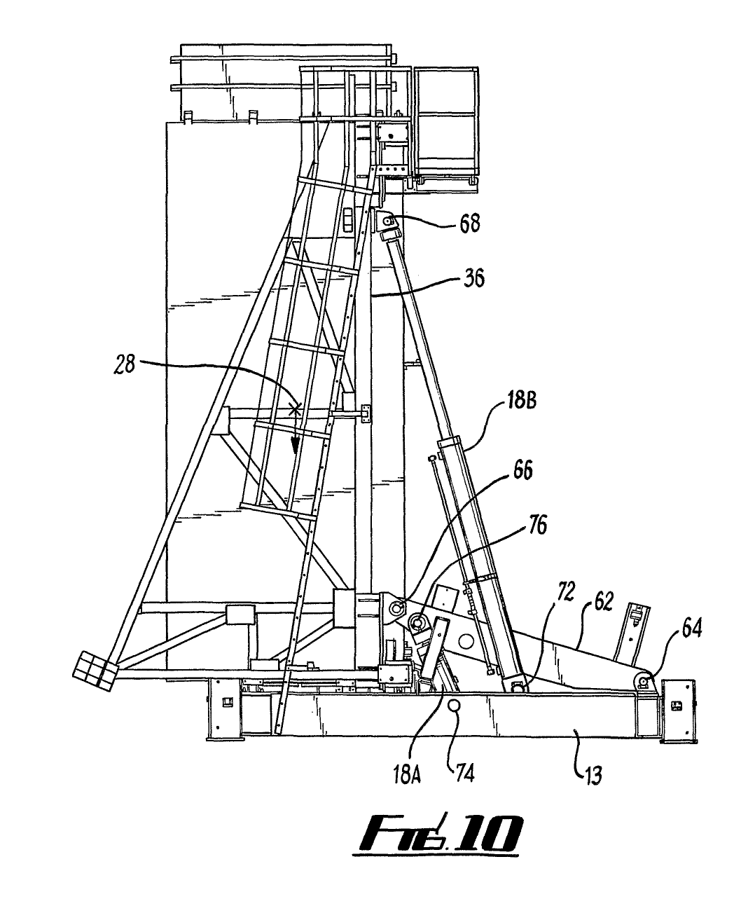

FIG. 10 is a side view of the apparatus in the second condition;

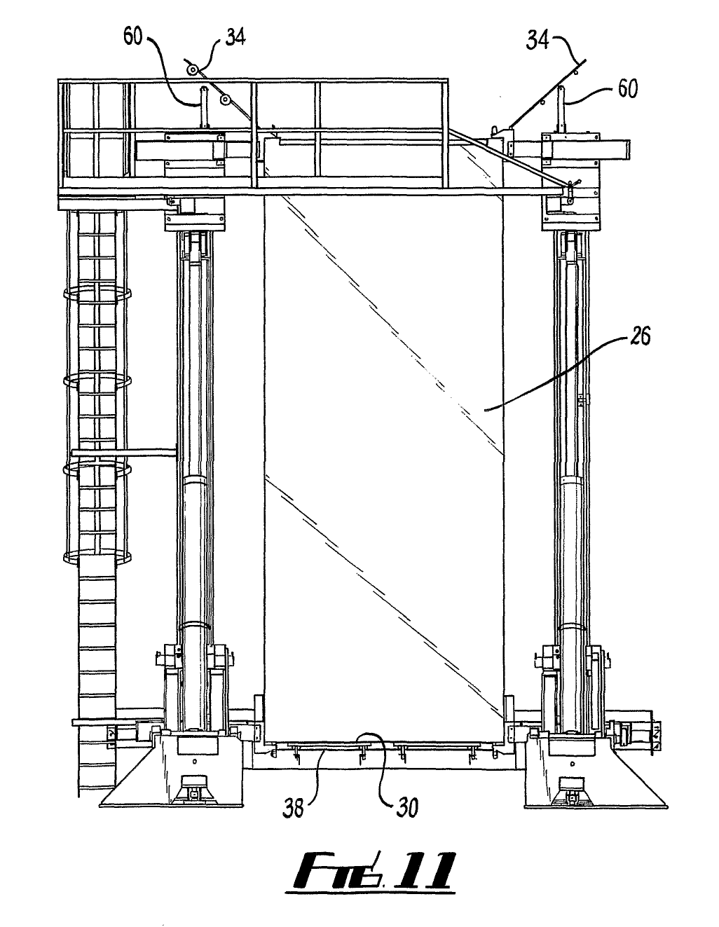

FIG. 11 is an end view in the second condition;

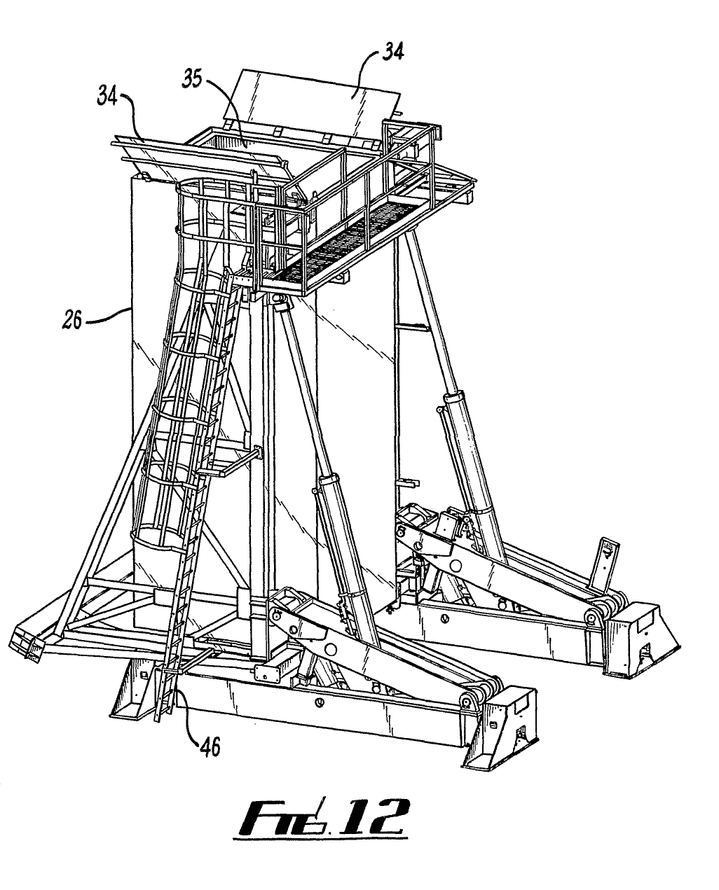

FIG. 12 is a perspective view in the second condition;

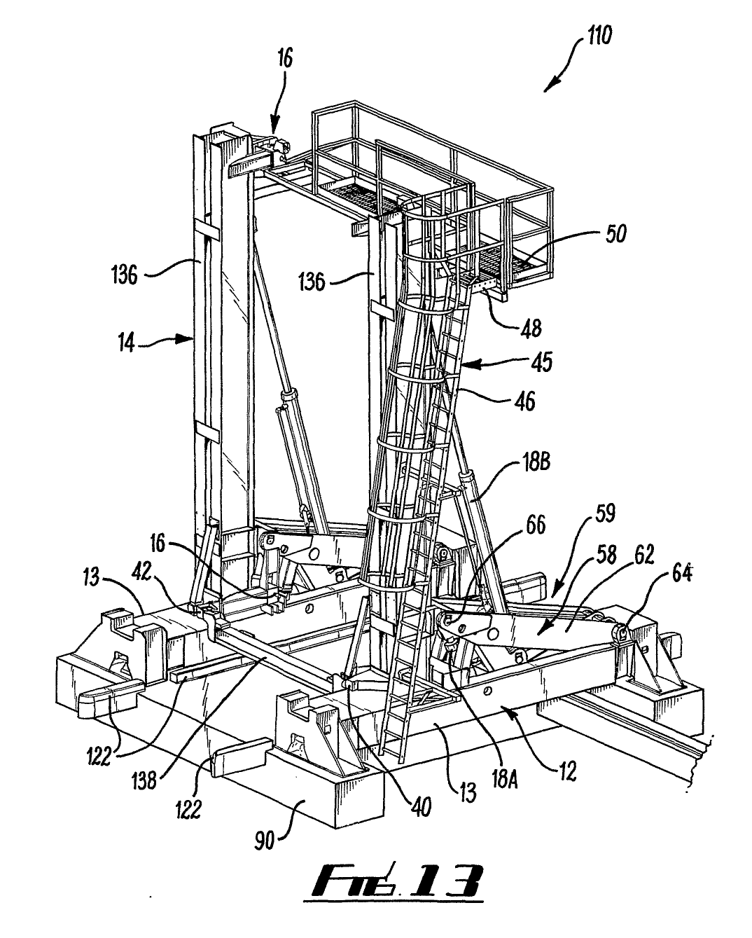

FIG. 13 is a perspective view of another container loading apparatus in a second condition;

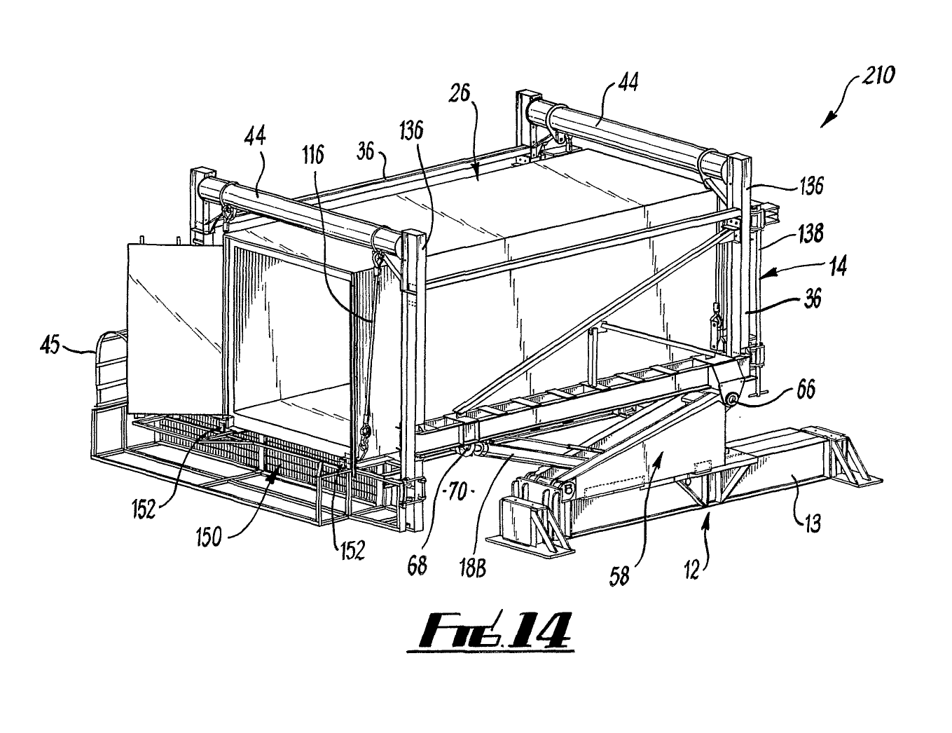

FIG. 14 is a perspective view of a further container loading apparatus in a first condition;

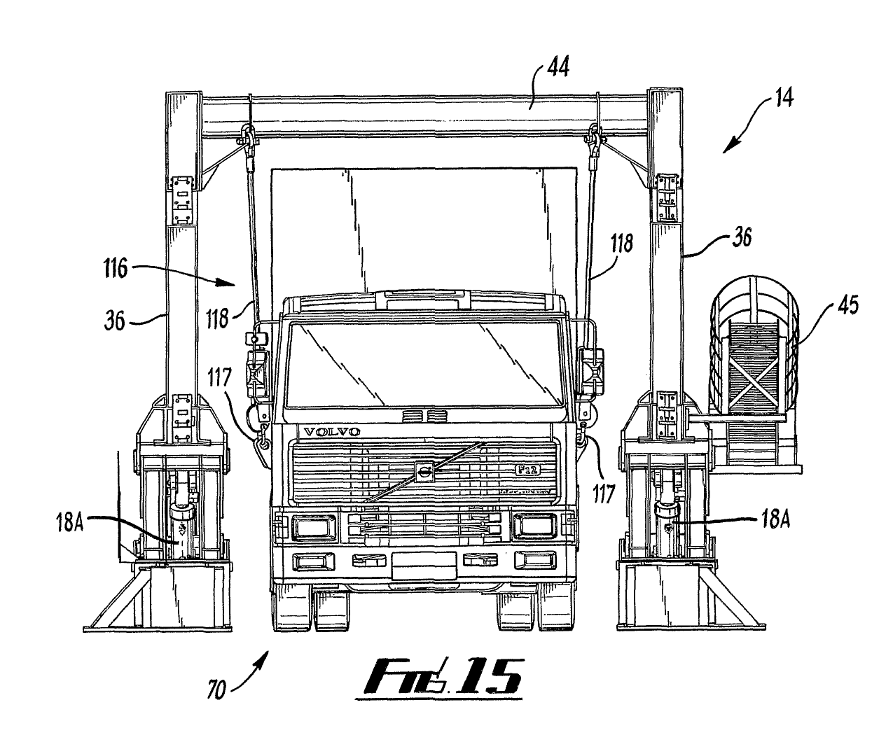

FIG. 15 is a front view of the apparatus FIG. 14;

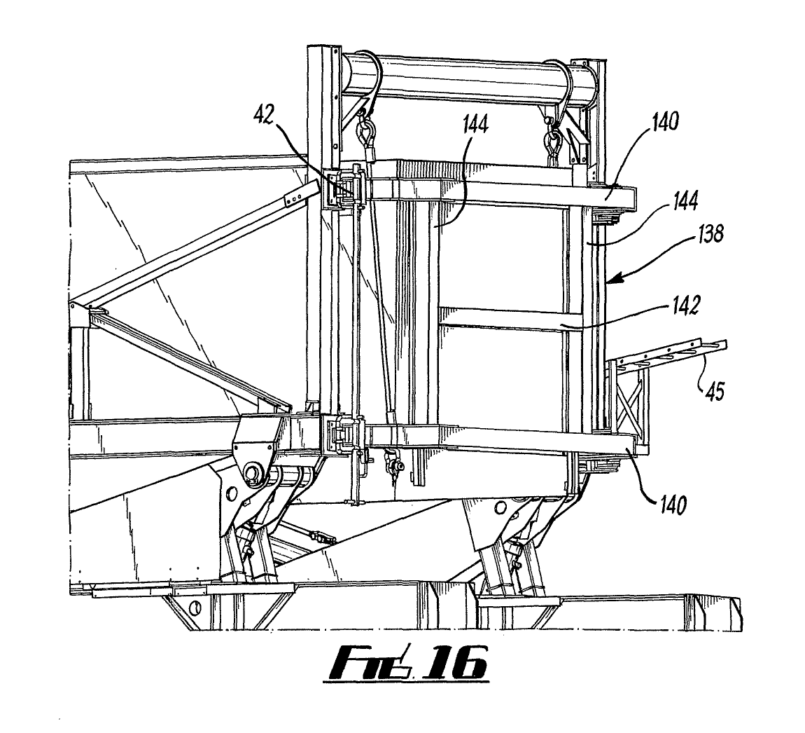

FIG. 16 is a perspective rear view of the apparatus of FIGS. 14 and 15; and

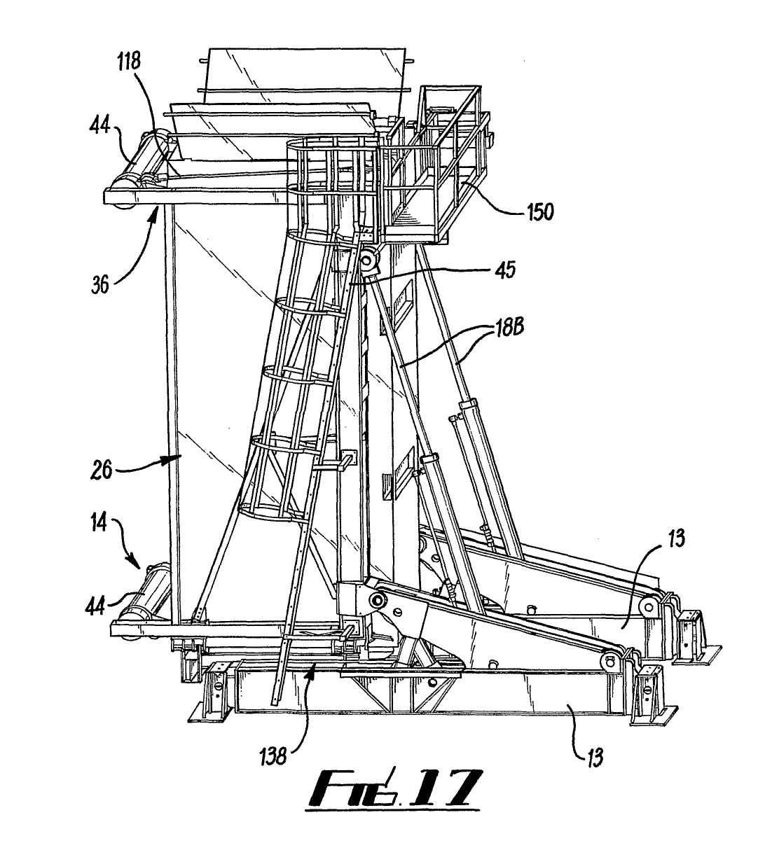

FIG. 17 is a perspective you of the apparatus of FIGS. 14 to 16 in a second condition.

As shown in FIGS. 1 to 3, container loading apparatus 10 includes a base frame 12, the base frame 12 comprising a pair of substantially parallel, spaced base frame beams 13 which define a loading space 70 therebetween. The apparatus 10 includes a support frame 14 and a mounting 58 for mounting the support frame 14 to the base frame 12.

FIGS. 1 and 2 show the apparatus 10 in a first condition, and FIG. 3 shows the apparatus 10 in a second condition. In the second condition, the support frame .14 is rotated through approximately 90° relative to its position in the first condition.

The support frame 14 includes a pair of spaced side frames 36 which are connected by a tie beam 44. In the example shown, the side frames 36 are substantially triangular when viewed from the side.

The mounting 58 includes a pair of mounting arrangements 59, each mounting arrangement 59 mounting one of the side frames 36 to one of the base frame beams 13.

Each mounting arrangement 59 includes a pair of relatively short actuators 18A and a pair of relatively long actuators 18B and a plurality of pivot mountings which connect the actuators to the base frame beams 13 and the side frames 36, as will be described in more detail below.

Details of the various pivot mountings may be seen most clearly in FIG. 10. Each mounting beam 62 extends between a lower support frame pivot mounting 66 mounted to one of the side frames 36 and a lower mounting beam pivot mounting 64 mounted on the respective base frame beam 13.

Each short actuator 18A extends between an upper short actuator pivot mounting 76 mounted on the mounting beam 62 and a lower short actuator pivot mounting 74 mounted on the respective base frame beam 13.

Each relatively long actuator 18B extends between an upper support frame pivot mounting 68 mounted to the side frame 36 and a lower long actuator pivot mounting 72 mounted on the corresponding base frame beam 13.

In the second condition as shown in FIG. 3, the side frames 36 are supported on the base frame beams 13, being received within notches 56 defined by the base frame beams 13.

The relatively short actuators 18A and the relatively long actuators 18B could be hydraulically powered.

The apparatus 10 includes an end wall support 38, a hinge mounting 40 mounting the end wall support 38 to one of the side frames 36, the end wall support 38 being movable between an open condition and a closed condition, the apparatus 10 including one or more locking devices 42 mounted to the opposite side frame 36 which are operable to lock the end wall support 38 in the closed condition.

The apparatus 10 includes a ladder arrangement 45 including a ladder 46 which is mounted to one of the side frames 36 and a fixed platform 48, which extends from one end of the ladder 46. The apparatus 10 includes a swinging walkway 50, a pivot mounting 52 mounting the swinging walkway 50 to the one side frame 36, the swinging walkway 50 being movable between a storage condition and a use condition.

The apparatus 10 could include guides 22 in the form of substantially parallel upstanding rails which extend along the surface of the ground in the loading space 70, and include flared portions at each end which extend outwardly away from each other. The guides 22 could be mounted to the base frame beams 13.

As shown in FIG. 2, the apparatus 10 includes a plurality of securing devices 16. In the example shown in FIG. 2, two securing devices 16 extend inwardly from each of the side frames 36. Each of the securing devices 16 includes an actuator 80, which could be hydraulically powered, which moves an engaging part 17 between a retracted and an extended position.

FIGS. 4 to 12 show steps in a method of loading the container 26. Initially, in a transport condition, the container 26 is carried by a vehicle 24 which in this example is a lorry or a truck, but in other examples could be, for instance, a railway locomotive or any other suitable vehicle.

The container 26 is of standardised construction, being elongate, including four side walls 32, an end wall 30, and a pair of doors 34 which are hingedly mounted to an opposed two of side walls 32. The container 26 defines an opening 35 at the end opposite to the end wall 30, and the doors 34 are movable to close the opening 35.

In the transport condition, the length of the container 26 extends substantially horizontally.

With the apparatus 10 in the first condition, the vehicle 24 drives forwardly into the loading space 70, the tyres of the vehicle 24 being guided by the guides 22 as shown in FIG. 4. With the vehicle 24 in position, the securing devices 16 operate to secure the container 26, moving the engaging parts 17 from the retracted position to the extended position to engage with engaging formations formed on the container 26.

Each engaging part 17 could include a securing fastener in the form of a bolt, screw or pin and each of the container engaging formations could define a hole or passage in which the fastener is receivable.

With the container 26 secured to the support frame 14, the short and long hydraulic actuators 18A, 18B operate to lift the support frame 14 and the container 26 vertically by a short distance, for instance, approximately 150 mm, moving the container 26 from the transport condition to an intermediate condition, in which the length of the container 26 still extends substantially horizontally, and moving the support frame 14 from the first condition also to an intermediate condition, so that the container 26 is lifted clear of the vehicle 24, permitting the vehicle 24 to be driven forwardly out of the loading space 70, clear of the apparatus 10.

As shown in FIGS. 5 and 6, in the transport condition, in which the container 26 is supported by the vehicle 24 and in the intermediate condition, in which the container 26 is supported by the support frame 14, the end wall support 38 is in the open condition and the swinging walkway 50 is in the storage condition. The end wall support 38 is now moved to the closed condition and the lock devices 42 operated to lock the end wall support 38 in the closed condition, as shown in FIG. 7. In the closed condition, the end wall support 38 is arranged to abut the end wall 30 of the container 26.

The doors 34 are opened, and the swinging walkway 50 is moved from the storage condition to the use condition by pivoting around the pivot mounting 52.

FIG. 8 is a side view of the apparatus 10 in the intermediate condition, with the end wall support 38 in the closed condition and the swinging walkway 50 in the use condition.

The relatively long actuators 18B are then operated as shown in FIG. 9, raising the upper support frame pivot mounting 68, so that the support frame 14 moves from the intermediate condition to the second condition by rotation through approximately 90° , moving the container from the intermediate condition to a loading condition as shown in FIGS. 10 to 12. In the loading condition, the length of the container 26 extends substantially vertically, the opening 35 facing upwards. In the substantially vertical loading condition, each open container door 34 rests against a door support 60, each of the door supports 60 extending from one of the side frames 36. The door supports 60 support the doors 34, so that the doors 34 are at an approximate angle of 45° to the vertical.

In the loading condition, material such as shredded scrap metal is loaded for example by means of a grab into the opening 35. The angled doors 34 help guide the material into the interior of the container 36. The end wall support 38 supports the container end wall 30 as material falls thereon, protecting the container end wall 30 from damage.

When the container 26 is full, the container doors 34 are shut. The doors 34 could be shut, for example, by the grab operator manoeuvring the grab to flip the doors into the closed position, or alternatively the doors can be shut manually.

In the second condition, the ladder 46 is arranged to extend from ground level up to the level of the swinging walkway 50 in the use condition, the fixed platform 48 corresponding with the swinging walkway 50, so that the ladder 46, the fixed platform 48 and the swinging walkway 50 provide an access path for a user from the ground up to the opening 35, so that when the container 26 is full, and the doors 34 are closed, the operator can lock the doors 34 in the closed condition.

Closing and locking the doors 34 with the container 26 in the substantially vertical loading condition provides a number of advantages. Filling of the container 26 can be maximised. There is no risk of material falling out during subsequent movement. The doors 34 can be shut easily without any material causing obstruction or resistance to the shutting of the doors.

When the doors 34 are locked, the operator then returns to ground level and the apparatus 10 operates so that the support frame 14 and container 26 return to the intermediate condition. In this condition, the vehicle 24 backs into position underneath the container 26, and the support frame 14 then moves from the intermediate condition to the first condition, correspondingly moving the container 26 from the intermediate condition to the transport condition, in which the full container 26 is now supported by the vehicle 24. The securing devices 16 are then operated to release the container 26, and the vehicle 24 with the full container 26 drives forwardly out of the loading space 70 and away from the loading apparatus 10.

The apparatus 10 provides a number of advantages. The loading space 70 is open at each end, so that the vehicle 24 can be driven forwardly into and through the apparatus 10. The vehicle 24 can be accurately positioned by means of the guides 22. Loading of the container 26 is rapid and safe, and the container doors 34 can be closed with the container 26 in the vertical loading condition. Following loading, the vehicle can be driven forwardly out of the apparatus. The facility of being able to drive the vehicle forwardly for the key movements in positioning the vehicle reduces the overall loading time significantly.

In FIGS. 8, 9 and 10, the approximate position of the centre of gravity 28 of the container 26 is shown in each condition. It will be noted that in each condition, the centre of gravity 28 is located above the loading space 70 defined by the base frame beams 13. This arrangement simplifies the requirements of the foundation design, reducing the overall costs of installation significantly, and ensures stability of the apparatus 10 in use.

Various other modifications could be made without departing from the scope of the invention. The various actuators could be of any suitable type. For example, electrical actuators could be used, or air operated actuators. The various components could be of any suitable size and shape. For example, the side frames of the support frame could be a shape other than triangular, for example, rectangular or trapezoidal. The support frame could include a plurality of tie beams. The locking devices could be of any suitable type.

In one example, the walkway 50 could be split into two parts, each part being pivotally mounted to an opposed side frame.

FIG. 13 shows another container loading apparatus 110, many features of which are similar to the container loading apparatus shown in FIGS. 1 to 12 and described above. Where features are the same or similar, same reference numerals have been used, and only those features which are different will be described for the sake of brevity.

In the container loading apparatus 110, the support frame 14 comprises a pair of side frames 36, each side frame 36 being in the form of a column or beam of relatively large cross section. As shown in FIG. 13, the relatively large cross section column or beam is formed of a pair of I-section members which are connected together to form a composite member. The composite member provides a number of advantages over the triangular side frame 36 of the container loading apparatus 10 shown in FIGS. 1 to 12. The composite member is relatively stronger, and therefore it is possible to use less material to obtain a structure having the same strength and thus save material weight. In turn, this has the desirable effect of enabling the diameter of the hydraulic cylinders forming the actuators 18A and 18B to be reduced, again saving weight.

The container loading apparatus 110 includes an end wall support 138 which is formed of a single member, in comparison with the end wall support 38 of the container loading apparatus 10 previously described, which is a structure formed of a plurality of members. Again the use of a simpler component saves weight and cost.

The overall saving in weight means that for transportation purposes, the apparatus shown in FIG. 13 can be transported in one load, whereas the apparatus shown in FIGS. 1 to 12 must be transported in two loads.

The container loading apparatus 110 shown in FIG. 13 also includes guides 122, which could be formed of concrete, and could be in the form of concrete kerbs, which are inset into a foundation 90. The use of concrete kerbs provides guides 22 which are relatively cheap and robust.

The container loading apparatus 110 shown in FIG. 13 operates in substantially the same way as the container loading apparatus 10 shown in FIGS. 1 to 12.

Referring now to FIGS. 14 to 17, a further container loading apparatus 210 is shown. Many of the features of the apparatus 210 are similar to the features of the container loading apparatus shown in FIGS. 1 to 13. Where features are the same or similar, the same reference numerals have been used.

Like the apparatus 10, the container loading apparatus 210 includes a base frame 12, comprising a pair of substantially parallel spaced beams 13. A loading space or region 70 is defined between the beams.

The apparatus 210 also includes a support frame 14 which comprises a pair of spaced side frames 36 connected by two tie beams 44.

The support frame 14 is mounted to the base frame 12 by means of a mounting 58. The mounting 58 comprises two pairs of actuators 18A and 18B, which are pivotally mounted as discussed above.

The apparatus 210 also includes a ladder arrangement 45 similar to that described above.

The apparatus 210 differs from the two embodiments described above in that the apparatus comprises securing devices 116 including a plurality of (in this case four) flexible securing members 118. In the example shown, the flexible securing members 118 comprise wire ropes, although it will be appreciated that other flexible securing members such as chains or cables could be used. A first end of each wire rope 118 is connected to a respective securing portion of a tie beam 44. The first ends of the wire ropes 118 are located so as to be spaced slightly further apart (for example 0.5 m, or 1 m further apart) than corners of the expected footprint of the container 26 to be lifted.

A second end of each wire 118 is provided with an engaging part 117 comprising in this instance a container lifting lug, for attaching to the container in a conventional way. In general, containers are provided as standard with a point to which such lugs can be attached.

The apparatus 210 further differs from those discussed above, in that a swinging walkway 150 (which is pivotally mounted to the support frame 14 so as to move from a first storage condition to a second use condition, like the walkway 50 discussed above) comprises a pair of location pins 152 which are arranged in use to be received in recesses which are generally provided on the base of a container 26. The location pins assist in guiding the container into a predetermined position relative to the support frame, and holding the container in that position once achieved.

The apparatus 210 also comprises an end wall support 138, shown best in FIG. 16. The end wall support 138, like the end wall support 38 described above, is movable between an open condition in which the container can be moved into the load space, and a closed condition in which a container is retained within the load space, as shown in FIG. 16. The end wall support 138 can be locked into the closed condition by means of one or more locking devices 42.

The end wall support 138 is arranged to support substantially the entire weight of the container when the apparatus is in the loading condition. To that end, the end wall support 138 comprises a frame which is strong enough to bear the weight of a fully loaded container. In this instance, the frame comprises a pair of beams 140 connected to an intermediate beam 142 by a pair of crossbeams 144. It will be appreciated that other constructions of frame might be used.

The end wall support is shaped so as to comprise a recess into which the end of the container 26 is received when the end wall support is in the closed condition. In use, the recess also acts hold the container in the predetermined position mentioned above.

The end wall support 138 may further or alternatively include one or more securing devices, for example a set of clamps, to hold the container firmly to the end wall support when the apparatus is in use. However, where the end wall is provided with a suitably shaped recess, such securing devices need not be provided.

In use, a container 26 is positioned within the loading space 70, for example by a truck as shown in FIG. 15. The securing devices 116 can then be connected to the container. Because the securing devices 116 are flexible it is not necessary to position the container as accurately within the loading of space as it is with the other container loading apparatus described above. Therefore it is not necessary to provide guides 22 to guide the driver of the truck accurately into position. In addition, the loading space, and in particular the width of the loading space, can be larger than in the other apparatus described herein. Thus the driver of the truck may be able to drive into the apparatus more quickly and confidently, with less fear of hitting the frame 12, 14 of the apparatus.

When the securing devices 116 are firmly connected to the container 26, the support frame 14 is raised from the first condition shown in FIG. 15 into the intermediate condition shown in FIG. 14 by way of the first actuators 18A. As the support frame 14 is raised, the container 26 is lifted free of the truck, the weight of the container being born by the securing devices 116 and the tie beams 44. It will be seen that the weight of the container is distributed substantially evenly across four support pillars 136 comprised in the support frame 14, reducing any tendency of the structure to twist under the weight of the container. This is particularly important when the apparatus pivots, as discussed later.

The driver of the truck is then able to drive the truck forward out of the loading space 70, leaving the container suspended within the loading space in the transport orientation.

The swinging walkway 150 is moved from the first storage condition to the use condition, for example manually by an operative. Similarly, the end wall support 138 is moved from the open condition to the closed condition. The container is now located in a predetermined position within the loading space 70 by location members in the form of the location pins 152 and the recess and/or securing device(s) provided on the end wall support. However, the majority of the weight of the container is still borne by the flexible securing members 118.

With the container firmly held in a predetermined position, the support frame 14 is moved from the intermediate position to the second position as shown in FIG. 17. As the support frame moves between the intermediate position and the second position the weight of the container is gradually transferred from the wire ropes 118 to the end wall support 138, until substantially the entire weight of the container is borne by the end wall support. The container is maintained in a substantially constant orientation with respect to the support frame during the rotation by the location members, which prevent the support devices 116 from pivoting around an axis defined by a respective tie beam 44.

Once the support frame reaches the second position, the container is now held in the loading position, and can be loaded with material in the same way as described above. The ladder 45 and walkway 150 allow an operative to access the door or doors of the container so that the operative can close the doors when required.

When the container has been loaded, and the doors of the container closed, the container can be returned to the transport position by moving the support frame 14 from the second condition back into the intermediate condition. As the frame is returned to the intermediate position the majority of the weight of the container and its load is transferred from the end wall support back to the flexible securing members 118. Again, the container is maintained in substantially a constant orientation with respect to the support frame by the location means.

Once in the intermediate condition, the walkway 150 and end wall support 138 can be disengaged from the container and returned to their respective stored and open positions. The weight of the container and its load is now borne entirely by the flexible securing members 118.

A truck can then be reversed into the loading space of the apparatus, and the support frame lowered from the intermediate condition to the first condition until the container rests on the bed of the truck. The flexible securing members 118 can then be disengaged from the container, leaving the truck free to be driven out of the load space and away.

The invention thus provides a container loading apparatus which permits the rapid and safe loading of containers with a loose non homogeneous material such as shredded scrap metal. The apparatus simplifies the vehicle movements required, as the vehicle can be forwardly driven into the apparatus and through the apparatus, and then when loading has finished and the container is again mounted to the vehicle, the vehicle can be driven forwardly out of the apparatus.

Various modifications may be made without departing from the scope of the invention. For example, other mounting means comprising different, or a different number of, actuators might be used. The first and second conditions need not be at substantially 90° to one another, and could be at could be at any desired angle. The apparatus need not necessarily move from the first condition to the second condition via an intermediate condition, but could move directly from the first condition to the second condition.

The apparatus might further comprise weighing means, which might be used to determine when the container 26 has been filled with a predetermined amount of material. In some embodiments, for example, one or both of the base frame beams 13 might function as a weighbridge.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

1. A container loading apparatus for loading a shipping container, the apparatus including a base frame, a support frame for supporting a container, a mounting for mounting the support frame to the base frame, one or more securing devices for securing the container to the support frame, and an actuator which is operable to move the support frame between a first condition and a second condition, wherein the securing devices comprise a plurality of flexible securing members.

2. An apparatus according to claim 1, wherein, in use, a container secured to the support frame is moveable between a transport condition corresponding to the first condition and a loading condition corresponding to the second condition.

3. An apparatus according to claim 1, wherein in the second condition the support frame is angled relative to its position in the first condition.

4. An apparatus according to claim 3, wherein in the second condition the support frame is rotated through approximately 90° relative to its position in the first condition.

5. (canceled)

6. An apparatus according to claim 1, wherein the apparatus defines a loading space which is open at each end, so that in use, a vehicle carrying a container can drive therethrough.

7. (canceled)

8. (canceled)

9. An apparatus according to claim 1, wherein the support frame comprises an end wall support, arranged in use to support an end wall of the container.

10. An apparatus according to claim 9, wherein the end wall support is arranged to bear substantially the entire weight of a container when the support frame is in the second position.

11. An apparatus according to claim 1, wherein the securing devices each comprise a respective engaging part, which is operable in use to engage with respective engaging formations provided on the container, so as to connect the securing device to the container.

12. (canceled)

13. An apparatus according to claim 1, wherein the flexible securing members are connected, in use, at a first end to the support frame and at a second end to the container.

14. An apparatus according to claim 1, wherein the flexible securing members comprise one of wire rope, chains and cables.

15. An apparatus according to claim 1, wherein an actuator is arranged to move, in use, the container between the transport condition and an intermediate condition in which the container is supported by the support frame, and between the intermediate condition and the loading condition.

16. An apparatus according to claim 1, wherein the apparatus is arranged so that in the first condition and/or the intermediate condition the weight of a container is substantially borne by the support devices.

17. An apparatus according to claim 1, wherein the apparatus includes a ladder arrangement.

18. (canceled)

19. An apparatus according to claim 1, wherein the apparatus includes a walkway, moveable between a storage condition and a use condition.

20. (canceled)

21. An apparatus according to claim 19, wherein in use, with a container secured to the support frame in the loading condition, and the walkway in the use condition, the ladder arrangement and the walkway together form an access path between the ground and an opening of the container.

22. An apparatus according to claim 1, wherein the apparatus comprises location members which in use maintain a container in a substantially constant orientation with respect to the support frame.

23. (canceled)

24. (canceled)

25. A method of loading a shipping container, the method including the steps of moving the container from a transport condition to a loading condition using a container loading apparatus as defined in claim 1, and loading the container in the loading condition.

26. (canceled)

27. The method of claim 25, wherein the container includes one or more doors, and the method includes the step of opening the or each container door in the transport condition.

28. (canceled)

29. The method of claim 25, wherein the container loading apparatus defines a loading space, and the method includes the step of a vehicle entering the loading space at one end carrying the container.

30. The method of claim 29, wherein the method includes the step of the container being lifted from the vehicle.

31. (canceled)

32. (canceled)
